(19) United States
(12) Patent Application Publication
(10) Pub. No.: US 2018/0060949 A1
(43) Pub. Date: Mar. 1, 2018

(54) SYSTEMS AND METHODS OF ENABLING RETAIL SHOPPING WHILE DISABLING COMPONENTS BASED ON LOCATION

(71) Applicant: Wal-Mart Stores, Inc., Bentonville, AR (US)

(72) Inventors: Todd D. Mattingly, Bentonville, AR (US); Matthew A. Jones, Bentonville, AR (US); Robert J. Taylor, Rogers, AR (US)

(21) Appl. No.: 15/690,649

(22) Filed: Aug. 30, 2017

Related U.S. Application Data
(60) Provisional application No. 62/381,800, filed on Aug. 31, 2016.

(51) Int. Cl. G06Q 30/06; G06F 21/62; H04N 13/04; G08B 21/18

(52) U.S. Cl. CPC G06Q 30/0643; G06Q 30/0623; G06F 21/6245; H04N 13/0048; G08B 21/182; G06Q 2220/10; H04N 13/0438

(57) ABSTRACT

In some embodiments, systems provide a customized retail shopping experience, comprising: a plurality of active shutter glasses systems (SGS) each comprising controllable lenses, wherein a first SGS is controlled to operate at a first frame profile to make a first content visible to a first customer, and a second SGS is controlled to operate at a different second frame profile to make a second content visible to the second customer; and a control circuit configured to: identify that the first SGS is located beyond a first threshold corresponding to the shopping facility; and cause the first SGS to be disabled when beyond the first threshold.

### CROSS-REFERENCE TO RELATED APPLICATION

This application claims the benefit of U.S. Provisional Application No. 62/381,800, filed Aug. 31, 2016, which is incorporated herein by reference in its entirety.

### TECHNICAL FIELD

This invention relates generally to providing a retail shopping experience.

### BACKGROUND

In modern retail environments, there is a need to improve the customer service and/or convenience for the customer. One aspect of customer service is a customer's ability to shop for products. There are numerous ways to allow a customer to shop. However, there is a need to improve a customer's ability to shop.

### BRIEF DESCRIPTION OF THE DRAWINGS

Disclosed herein are embodiments of systems, apparatuses and methods of providing a retail shopping experience. This description includes drawings, wherein:

FIG. 1 illustrates a simplified block diagram of an exemplary retail customization system that provides customized virtual retail shopping experiences to multiple customers, in accordance with some embodiments.

FIG. 2 illustrates an exemplary system for use in implementing methods, techniques, devices, apparatuses, systems, servers, sources and providing a customized shopping experience, in accordance with some embodiments.

FIG. 3 illustrates a simplified block diagram of an exemplary process of providing a customized retail shopping experience for customers at a shopping facility, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to providing a customized retail shopping experience. In some embodiments, a system includes a central control system and a plurality of active shutter glasses systems (SGS) that can temporarily or permanently be associated with a particular customer. The SGSs are configured to be used at a retail shopping facility to enable the corresponding customer to see displayed products and/or product information that is intended for that customer. Each of the SGSs includes controllable lenses and is configured to selectively control rates of when one or both of the lenses are opaque and/or when a person can see through one or both of the lenses. Different SGSs can be associated with a different customer at least while at the shopping facility. The SGSs can further be configured to operate at different frame profiles to make different content, intended for different customers, visible to the different customers. Further, the different frame profiles can prevents other customers from seeing the content intended for a different customer. A control circuit of the system can further detect that an SGS is located beyond a threshold corresponding to the shopping facility and cause that SGS to be disabled when beyond the threshold.

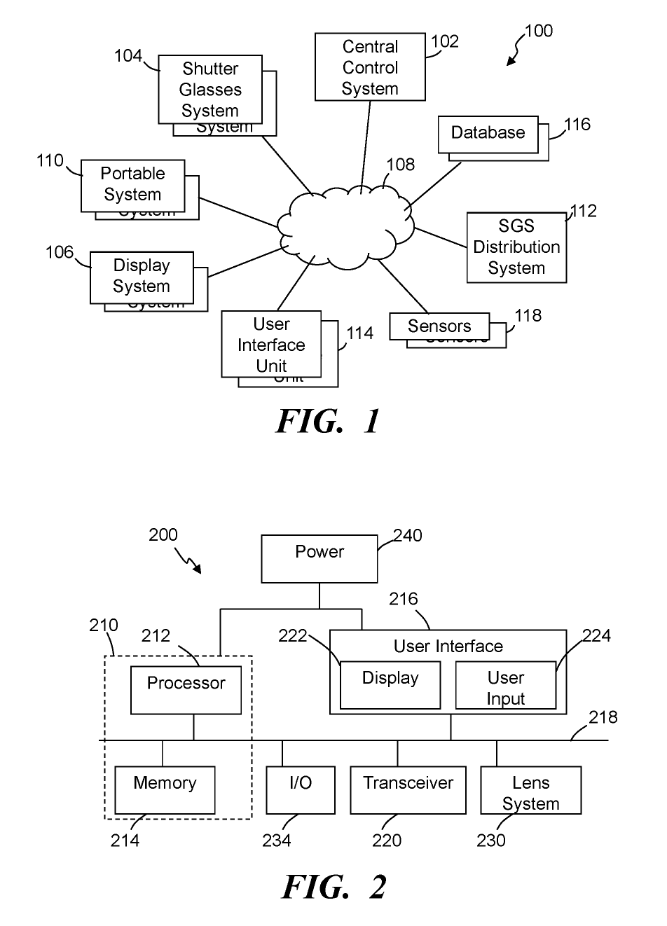

FIG. 1 illustrates a simplified block diagram of an exemplary retail customization system 100 that provides customized virtual retail shopping experiences to multiple customers at one or more shopping facilities, in accordance with some embodiments. The system includes one or more central control systems 102 in wireless and/or wired communication with multiple shutter glasses systems (SGS) 104 and multiple display systems 106 over a distributed computer and/or communication network 108. In some implementations, the system further includes one or more SGS distribution systems 112. In some embodiments, the system includes and/or communicates with customers' and/or workers' user interface units 114. Further, the system includes one or more sensors 118 and/or sensor systems. The sensors can include substantially any relevant sensor, such as wireless communication sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, motion sensors, RFID readers, cameras, image processing systems, other such sensors or combination of two or more of such sensors. The sensors can be positioned at various locations in the shopping facility, and typically one or more sensors are positioned proximate one or more threshold boundaries within and/or exterior to the shopping facility. In some embodiments, the user interface units can provide sensor information and be considered part of the sensor system(s). The user interface units can be one or more of a variety of user interface units including, but not limited to, mobile and/or handheld electronic devices such as so-called smart phones and portable computers such as tablet/pad-styled computers, custom shopping facility units (e.g., scanners, two-way communication devices, etc.), and other such devices. The shopping facility may be any size or format facility, and may include products from one or more merchants. For example, a facility may be a single store operated by one merchant or may be a collection of stores covering multiple merchants such as a mall.

The central control system 102 communicates with the multiple SGSs 104 and can provide instructions to at least partially control the operation of the multiple SGSs. In some implementations, the SGSs are configured to selectively control rates of when one or both of the lenses are opaque or affect a person's ability to see through the lens or lenses, and when a person can see through one or both of the lenses (e.g., when one or more both of the lenses are transparent). The central control system can, in part, cause instructions, lens control timing, rates and/or code to be communicated to individual SGSs regarding frame profiles used by the respective SGSs to control when one or both of the lenses are to be transparent and/or enable a customer (or other user) to see through the lens or lenses.

The display systems 106 include displays that are placed at locations in the shopping facility that are visible to and/or accessible to customers. In some instances, multiple displays are positioned adjacent to each other and can cooperatively display product content across multiple displays. For example, in some instances, one or more display systems are positioned along at least part of an aisle. Product content can be displayed through the display systems so that as a customer views the product content the display depicts an aisle full of different products that are for sale through the shopping facility. Further, in some embodiments the product content is displayed to appear as three-dimensional to the customer. In some embodiments, the display systems further include display control circuits that can control frame profiles at which one or more sources of product content are displayed. Additionally or alternatively, one or more product contents are supplied, by one or more content supply systems that may be part of or separate from the central control system, to a display system at desired display frame profiles, and the display system displays the frames as received from the content supply system consistent with the desired display frame profiles. Some embodiments may further provide frame profile information to be used by the one or more display systems and/or the content sources to control the frame profiles at which one or more product content and/or other content is displayed. The frame profile information may be specific to a single content, or may have frame profiles for different content that are intended to be displayed through a display system or multiple display systems. Further, the frame profile information may specify multiple different frame profiles for a single content and timing regarding when to apply the multiple different frame profiles. In other instances, updated frame profile information may be communicated identifying a change in frame profile of one or more contents, and in some instances timing information regarding when to apply the changed frame profiles. Some embodiments may specify frame profile modulation information defining changes in frame profiles and the modulation rate or timing at which the frame profile is to be modulated.

Some embodiments include one or more SGS distribution systems 112 that are configured to associate customers with SGSs in use within the shopping facility. For example, in some embodiments, the SGSs will be issued to customers for use while in the shopping facility, and typically temporarily issued to customers. The SGS distribution system can obtain customer identifying information (e.g., a customer name, a customer number, a customer credit card number, finger print, eye and/or retinal image, other such information or combination of such information) and associate an SGS identifier of an SGS issued to that customer (or a person associated with that customer, such as a child, spouse, guest, etc.) and associate the SGS identifier with the customer based on the customer identifying information. In some applications, the SGS dispensing system may be operated in part with a shopping facility worker (e.g., worker hands out the SGSs to customers, and may direct the acquisition of the SGS identifier, such as through scanning a bar code, moving the SGS proximate an RFID reader, manually entering in an SGS identifier through a user interface of the SGS distribution system or other device in communication with the SGS distribution system or central controller), the SGS dispensing system may be a kiosk or vending machine type system that allows customers to present identifying information (e.g., detect a customer card, read a credit card, detect an RFID tag carried by the customer, receive a communication from a customer's user interface unit, etc.) and dispense one or more SGSs (e.g., in response to confirming a customer's identifying information), or the SGS dispensing system may be implemented through other such applications. In some embodiments, the SGS dispensing system may additionally or alternatively detect a customer owned SGS as the customer enters the shopping facility or travels through the shopping facility (e.g., based on an RFID tag of the SGS) and obtain customer identifier information through a customer database and/or through other methods.

In some embodiments, the system includes and/or communicates with one or more user interface units 114 that are associated with customers and/or workers of the shopping facilities. The user interface units can be one or more of a variety of user interface units including, but not limited to, mobile and/or handheld electronic devices such as so-called smart phones and portable computers such as tablet/pad-styled computers, custom shopping facility units (e.g., scanners, two-way communication devices, etc.), and other such devices. Some or all of the user interface units may wirelessly communicate with the central control system over one or more of the computer and/or communication networks 108 (e.g., Wi-Fi wireless network, cellular, Bluetooth, Ethernet, etc.).

Further, the circuits, circuitry, systems, devices, processes, methods, techniques, functionality, services, servers, sources and the like described herein may be utilized, implemented and/or run on many different types of devices and/or systems. FIG. 2 illustrates an exemplary system 200 that may be used for implementing any of the components, circuits, circuitry, systems, functionality, apparatuses, processes, or devices of the system 100, and/or other above or below mentioned systems or devices, or parts of such circuits, circuitry, functionality, systems, apparatuses, processes, or devices. For example, the system 200 may be used to implement some or all of the central control system 102, shutter glasses systems 104, controllable lenses and/or lens control sub-systems, the display systems 106, the SGS distribution systems 112, the user interface units 114, the databases 116 and/or systems implementing the databases, and/or other such components, circuitry, functionality and/or devices. The databases can include one or more customer databases that store information corresponding to multiple different customers, one or more product databases that store information about products (e.g., information about products, pricing information, product value vectors, images, scans, three-dimensional representations, etc.), one or more content database identifying where to access and/or storing the product content and/or other content, inventory database identifying inventory information (e.g., listings of available inventory, location information, pricing, etc.), other such databases, or combinations of two or more of such databases. However, the use of the system 200 or any portion thereof is certainly not required.

By way of example, the system 200 may comprise a control circuit or processor module 212, memory 214, and one or more communication links, paths, buses or the like 218. Some embodiments may include one or more user interfaces 216, and/or one or more internal and/or external power sources or supplies 240. The control circuit 212 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 212 can be part of control circuitry and/or a control system 210, which may be implemented through one or more processors with access to one or more memory 214 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 200 may be used to implement one or more of the above or below, or parts of, components, circuits, systems, processes and the like. For example, the system may implement the central control system with the control circuit being a central control circuit, an SGS with an SGS control circuit, a display system with a display control circuit, an SGS distribution system with a distribution control circuit, or other components.

The user interface 216 can allow a user to interact with the system 200 and receive information through the system. In some instances, the user interface 216 includes a display 222 and/or one or more user inputs 224, such as buttons, touch screen, track ball, keyboard, mouse, etc., which can be part of or wired or wirelessly coupled with the system 200. Typically, the system 200 further includes one or more communication interfaces, ports, transceivers 220 and the like allowing the system 200 to communicate over a communication bus, a distributed computer and/or communication network 108 (e.g., a local area network (LAN), the Internet, wide area network (WAN), etc.), communication link 218, other networks or communication channels with other devices and/or other such communications or combination of two or more of such communication methods. Further the transceiver 220 can be configured for wired, wireless, optical, fiber optical cable, satellite, or other such communication configurations or combinations of two or more of such communications. Some embodiments include one or more input/output (I/O) ports 234 that allow one or more devices to couple with the system 200. The I/O ports can be substantially any relevant port or combinations of ports, such as but not limited to USB, Ethernet, or other such ports. The I/O interface 234 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The system 200 comprises an example of a control and/or processor-based system with the control circuit 212. Again, the control circuit 212 can be implemented through one or more processors, controllers, central processing units, logic, software and the like. Further, in some implementations the control circuit 212 may provide multiprocessor functionality.

The memory 214, which can be accessed by the control circuit 212, typically includes one or more processor readable and/or computer readable media accessed by at least the control circuit 212, and can include volatile and/or nonvolatile media, such as RAM, ROM, EEPROM, flash memory and/or other memory technology. Further, the memory 214 is shown as internal to the control system 210; however, the memory 214 can be internal, external or a combination of internal and external memory. Similarly, some or all of the memory 214 can be internal, external or a combination of internal and external memory of the control circuit 212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 108. The memory 214 can store code, software, executables, scripts, data, content, lists, programming, programs, log or history data, user information, customer information, product information, and the like. While FIG. 2 illustrates the various components being coupled together via a bus, it is understood that the various components may actually be coupled to the control circuit and/or one or more other components directly.

Further, in some embodiments where the system 200 implements some or all of the SGSs 104, the system can include lens systems 230, which can include controllable lenses and/or lens control circuits. The lens systems can control when one or both lenses can be seen through and when a user cannot see through the lenses. The control can be based on a frame profile and/or timing of content intended to be viewed through the SGS.

The customization system 100 can be configured to provide different customized retail shopping experiences for different customers. Further, in at least some instances, the system can simultaneously provide different customization experiences for different customers. The system utilizes the plurality of active SGSs 104 that each comprises controllable lenses. Accordingly, each of the SGSs is configured to selectively control rates of when one or both of the lenses can be seen through (e.g., are transparent, tinted, partially transparent, etc.) and when one or both lenses inhibits or prevents a user from seeing through at least part of the lens or lenses. For example, in some applications the SGSs control when one or both of the lenses are opaque and when one or both of the lenses are transparent.

The central control system is associated with at least one retail shopping facility. In some implementations, the central control system is implemented at the shopping facility, while in other implementations part or all of the central control system may be implemented remote from the shopping facility. Further, the central control system is separate from the SGSs, and is configured to be in wireless communication with each of the plurality of SGSs at least while the SGSs are within one or more areas within the shopping facility and/or within a threshold distance of one or more areas of an interior of the shopping facility. For example, the shopping facility may have limited areas where the SGSs are effective because of limited placement of display systems, while in other implementations, large areas or all of the sales floor of a shopping facility may include display systems. In some embodiments, the wireless communication is implemented with a limited effective communication range, such as through Wi-Fi, Bluetooth, Bluetooth low energy, ZigBee, radio frequency, other such wireless communication methods, or combination of two or more of such methods.

In providing the customized experience, the central control system can control what content is made visible to different customers by controlling frame profiles of different content, and coordinating the control of the lenses of corresponding SGSs. In some embodiments, the central control system identifies different frame profiles at which different SGSs are to make visible different product content intended for different customers while at the shopping facility. For example, the central control system can identify a first frame profile at which a first SGS is to make visible a first product content intended to be viewed by a first customer, and identify a different second frame profile at which a second SGS is to make visible a second product content intended to be viewed by a second customer. As introduced above, the frame profiles may be constant for one or more SGSs, may vary over time for one or more SGSs, may be modulated, or the like.

In some embodiments, for example, a first SGS can be configured to operate at a first frame profile at which the first SGS is to make a first content, intended for a first customer, visible to the first customer, and a second SGS can be configured to operate at a different second frame profile at which the second SGS is to make a second content, intended for a second customer, visible to the second customer. When controlled based on the frame profiles, the first SGS based on the first frame profile enables the first customer to view the first content while preventing the first customer from seeing the second content, and the second SGS based on the second frame profile enables the second customer to view the second content while preventing the second customer from seeing the first content. Similarly, other content may be visible on the same display as the first and second content but at a different frame profile. For example, with four users a single display can control frames of four different content to be sequentially displayed at 60 frames per second with a display providing 240 Hz screen rate; a similar display can enable frames of six different content to be rendered at 40 frames per second allowing six different users to view the different content with the lenses SGSs controlled at substantially the same rate; and a similar display can enable frames of eight different content to be rendered at 30 frames per second allowing eight different users to view the different content with the lenses SGSs controlled at substantially the same rate. In other implementations, additional content may be displayed on one or more displays that may be visible to more than one use and/or customers that are not using SGSs. For example, some embodiments may direct two different contents intended for two different customers at a frame rate of 60 frames per second while one or more frames of a third content is displayed over 120 frames per second with the display having a 240 Hz screen rate. Other frame profiles can be used. When fewer users are viewing a display, other content, a white screen, a black screen, a pre-programmed message or other content can be displayed. This implementation may make the other content visible to customers with or without SGSs.

As another example, with a display having a 240 Hz screen rate, the frame profiles for two contents to be displayed in 3-D can be defined in some instances with at 60 frames per second (e.g., 60 FPS content 1 left eye, 60 FPS content 2 left eye, 60 FPS content 1 right eye, 60 FPS content 2 right eye); three contents displayed at 40 frames per second (e.g., 40 FPS content 1 left eye, 40 FPS content 2 left eye, 40 FPS content 3 left eye, 40 FPS content 1 right eye, 40 FPS content 2 right eye, 40 FPS content 3 right eye); four contents displayed at 30 frames per second (e.g., 30 FPS content 1 left eye, 30 FPS content 2 left eye, 30 FPS content 3 left eye, 30 FPS content 4 left eye, 30 FPS content 1 right eye, 30 FPS content 2 right eye, 30 FPS content 3 right eye, 30 FPS content 4 right eye). Additionally or alternatively, some embodiments modify and/or modulate the frame profiles and/or rates at which frames are displayed and that one or more lenses of one or more SGSs are controlled.

The location of the SGSs can be identified while within the shopping facility and/or while within a threshold distance of the shopping facility. The location can be determined based on sensing the SGSs (e.g., RFID, image processing, etc.), determining a location based on communications from the SGSs, receiving communications from the SGSs, detecting optical signals generated from the SGSs, receiving sensor data from SGSs (e.g., inertial sensor data, motion sensor data, wireless signal information, etc.), tracking movement of a customer associated with the SGS (e.g., RFID, image processing, facial and/or body recognition, communication from a user interface unit associated with the customer, etc.), and/or other such methods. Further, some embodiments can identify and/or determine a direction or orientation of the SGSs and/or the lenses of the SGSs (e.g., based on sensor data from the SGSs, image processing, detecting optical signal from the SGSs, etc.).

Using the location and/or orientation information, the central control system can identify one or more display systems 106 that are within a threshold distance of a particular SGSs, within a threshold angle relative to an orientation of the SGS, within a threshold predicted or potential movement of the SGSs, and/or other such considerations. The predicated movement can be based on a customer's movement patterns through the shopping facility during a current visit to the shopping facility, customers historic movements through shopping facilities, shopping list information available to the central control system (e.g., based on customer profile information), predicted purchases (e.g., based on historic purchases of a specific customer or one or more groups of customers, advertisements presented to the customer, value vectors of one or more customers, other such information, and often a combination of two or more of such information), other such information or combination of two or more of such information.

The central control system can direct product content to be displayed on one or more displays of one or more display systems that are located relative to the location of a particular customer. The product content is further displayed at the frame profile corresponding to the particular SGS so that the product content is visible through the particular SGS to the customer. Further, the particular SGS is controlled to coordinate the control of one or more lenses to correspond with and/or be synchronized with the frame profile so that the one or more lenses are transparent or otherwise configured so that the customer can see through at least a portion of one or both lenses when the frames of the specific product content intended to be viewed by the particular customer are displayed on the one or more displays. For example, some embodiments provide SGSs having two distinct lenses (e.g., right and left eye). The SGS can be controlled to right and left lenses to both be synchronized with a frame profile of the content, while in other instances, the right and left lenses can be separately synchronized to frame profiles to enable content to appear three-dimensional. Other embodiments employ SGSs with a single lens or “visor” that is continuous to cover both left and right eyes. This single lens configuration can be controlled according to a single frame profile so that the user can simultaneously see through the single lens with both eyes. Still other embodiments using a single lens SGS and can define sub-lenses within the single lens to enable the SGS to be controlled for each eye, which may be used for example to provide 3-D visual effects.

Further, the frame profile is selected so that frames of the product content will not visible, through a different SGS, to a different second customer. In some embodiments, the frame profile of a first product content and the corresponding lens control timing and/or rate of a first SGS are selected and/or controlled based in part on other SGSs that are within a threshold distance and/or orientation of the one or more displays selected to display the first product content and the lens control timing of those other one or more SGSs. The control circuit can, in some implementations, identify when one or more other SGSs are within the threshold distance and/or orientation of the selected displays and can identify the frame profiles and/or lens control timing associated with those other SGSs. Based on the other frame profiles and/or lens control timing associated with these other SGSs, the central control system can control the frame profile of the first product content to be different from those other frame profiles and/or lens control timing so that the lenses of the other SGSs are opaque while frames of the first product content are displayed and the other customers wearing those other SGSs cannot see the frames of the first product content.

In some embodiments, the displayed content can include virtual renderings on one or more displays of a set of one or more products. Further, in some instances, the virtual rendering displays a set of one or more products three-dimensionally positioned on a set of one or more rendered virtual shelves that when displayed appear to extend along at least a portion of an aisle such that when visible through an SGS depicts a portion of a sales floor of a retail shopping facility with the set of virtual products corresponding to multiple of the products of interest, and which are typically available for purchase through the shopping facility. Accordingly, in some applications the virtually rendered products can display a virtual aisle of products from which the customer can select one or more products. The customer can move along the aisle and select one or more of the displayed products, such as by touching the display on a displayed product, detecting a direction the customer is looking for more than a threshold period of time, etc. The display system can detect the touch and based on a location of the touch the system can identify the product being touched. Some embodiments further display options to the customer in response to the touching or other selection (e.g., option to select a quantity, option to select a size, option to select a quantity, option to select a color, option to get additional information about a product, option to compare one or more products, option to request delivery of a product, other such options, or combination of two or more options). In some instances, some or all of the options may be displayed through a user interface unit associated with the customer.

Using the location and/or orientation information, the central control system can identify one or more display systems 106 that are within a threshold distance of a particular SGSs, within a threshold angle relative to an orientation of the SGS, within a threshold predicted or potential movement of the SGSs, and/or other such considerations. The predicated movement can be based on a customer's movement patterns through the shopping facility during a current visit to the shopping facility, customers historic movements through shopping facilities, shopping list information available to the central control system (e.g., based on customer profile information), predicted purchases (e.g., based on historic purchases of a specific customer or one or more groups of customers, advertisements presented to the customer, value vectors of one or more customers, other such information, and often a combination of two or more of such information), other such information or combination of two or more of such information.

The central control system can direct content to be displayed on one or more displays of one or more display systems that are located relative to the location of a particular customer. The content is further displayed at the frame profile corresponding to the particular SGS so that the content is visible through the particular SGS to the customer. Further, the particular SGS is controlled to coordinate the control of one or more lenses to correspond with and/or be synchronized with the frame profile so that the one or more lenses are transparent or otherwise configured so that the customer can see through at least a portion of one or both lenses when the frames of the specific content intended to be viewed by the particular customer are displayed on the one or more displays.

Further, the frame profile is selected so that frames of the content will not visible, through a different SGS, to a different second customer. In some embodiments, the frame profile of a first content and the corresponding lens control timing and/or rate of a first SGS are selected and/or controlled based in part on other SGSs that are within a threshold distance and/or orientation of the one or more displays selected to display the first content and the lens control timing of those other one or more SGSs. The control circuit can, in some implementations, identify when one or more other SGSs are within the threshold distance and/or orientation of the selected displays and can identify the frame profiles and/or lens control timing associated with those other SGSs. Based on the other frame profiles and/or lens control timing associated with these other SGSs, the central control system can control the frame profile of the first content to be different from those other frame profiles and/or lens control timing so that the lenses of the other SGSs are opaque while frames of the first content are displayed and the other customers wearing those other SGSs cannot see the frames of the first content. By controlling the timing of displayed frames of different content and similarly controlling lenses of different SGSs, some embodiments enable different content to be displayed on the same display (or displays) while different customers are both looking at the display (or displays) while each customer only sees those frames of the content intended for the respective customer.

As described above, the central control system can be configured to associate and/or can receive information of the association of SGSs with specific customers. In some instances, the central control system can receive sensor data with SGS identifier information of a specific SGS and can further receive sensor information that is used to identify a customer that has retrieved or is provided the specific SGS. For example, an RFID tag of the specific SGS can be received that identifies the SGS, and the specific SGS may be distributed through a kiosk to the customer in response to the customer providing identifying information (e.g., swiping a customer card, swiping a credit card, facial recognition, entering a specific code or pin associated with the customer, detecting a user interface unit 114 associated with a customer, other such identifying information or combination of such information). Additionally or alternatively, the SGS distribution system 112 can obtain relevant SGS identifier information and communicate that information to the central control system. In some embodiments, the SGS distribution system may also obtain customer identifier information and communicate that information to the central control system and/or an SGS database that maintains information about the SGSs, associated customer identifiers, status information, operating condition information and/or other relevant information that can be used by the central control system and/or SGS distribution system.

Further, the system can limit and/or cause the SGSs and/or other systems to be at least partially disabled when the SGSs and/or other systems are moved beyond one or more thresholds and/or outside of an area. For example, the customization system 100 can cause an SGS 104 to be at least partially disabled when within a threshold distance of an exit of the shopping facility, beyond a threshold distance from an exit of the shopping facility, within a threshold of a parking lot, and/or other such thresholds. Additionally, in some application, the disabling of the SGS can make the SGS unusable beyond one or more thresholds, which can discourage customers leaving the shopping facility with the SGSs.

Similarly, in some applications the central control system 102 can cause one or more other mobile systems to be disabled and/or modify the operation of one or more systems when those systems are transported beyond one or more corresponding boundaries and/or thresholds. Alternatively or additionally, the control circuit of the other portable shopping facility supplied systems 110 may disable and/or modify the operation of the respective system. Such other systems may include, but are not limited to portable product identifying systems (e.g., RFID tag reader systems, Scan&Go or other portable customer scan and purchase systems (such as the Scan&Go systems utilized at some Wal-Mart stores, Sam's Club stores, and the like), product scanning systems (e.g., bar code scanners, image recognition scanners, etc.), and the like), communication headsets, audio/video virtual reality glasses, smart carts, and/or other such systems.

In some embodiments, a plurality of portable shopping facility supplied systems 110 are communicatively coupled with a control circuit. The control circuit of the central control system 102 and/or a first portable system 110 can be configured to identify that a first portable system, of the plurality of shopping facility supplied systems, is beyond a first boundary corresponding to the shopping facility and the first portable system. The control circuit can cause the first portable system to be disabled and/or otherwise to modify the operation of the portable system when beyond the first boundary. In some implementations, the portable systems and/or SGSs may include sensors and/or location detection systems to obtain location information that can be used to determine a location (e.g., RFID tag sensors, light decoding sensor, wireless communication triangulation systems, bar code scanners, GPS systems, and/or other such information), and/or can receive information form one or more location transmitting devices positioned at locations within the store. Additionally or alternatively, the portable systems 110 and/or SGSs 104 can transmit identifier information to one or more external systems (e.g., RFID tag readers, bar code readers, optical sensors, or the like) that can be communicated to the central control system to determine a location of the portable systems and/or SGSs.

In some embodiments, a control circuit 210 can identify or detect that an SGS is located beyond one or more thresholds corresponding to a shopping facility. The identification may be based on sensor data, communications and/or other such methods. In some instances, for example, the control circuit may be a central control circuit of the central control system 102 that identifies based on one or more sensors 118 that an SGS is beyond a threshold. The sensor data may be RFID tag information detected by an RFID tag reader located proximate an exit of the shopping facility that detects an RFID tag of the SGS, the sensor data may be wireless communication signal strength information indicating that the SGS has moved beyond a threshold distance, the sensor data may be image processing information that identifies an SGS beyond a threshold (e.g., approaching an exit, beyond an SGS return location and/or system (e.g., an SGS distribution system), outside of the shopping facility, or the like), the sensor data may be location information obtained by the SGS (e.g., based on GPS information, RFID reader information, etc.), the sensor data may be location information and/or other information received from a user interface unit of the customer associated with the SGS, other such sensor data, or combination of such data. The control circuit 210 may be part of the central control system 102, an SGS 104, an SGS tracking system, other such system, or a combination of such systems. For example, the control circuit may be a central control circuit of the central control system 102 that can receive sensor information and/or notification regarding the location of the SGS, which may indicate a crossing of a threshold or boundary, and identify that the SGS is beyond a threshold. In other implementations, the control circuit may be an SGS control circuit of an SGS 104 that provides at least some control over the operation of the SGS. The SGS control circuit may receive location information from a local sensor, may receive a wireless notification from the central control system 102 regarding the location of the SGS and/or the SGS being beyond a threshold boundary, and/or other such information.

The control circuit is further configured to cause an SGS to be at least partially disabled when beyond the threshold. In some embodiments, the system can be configured so that the SGSs only properly work while within one or more threshold boundaries and/or one or more virtual geofences. By disabling the SGSs, the system can inhibit some customers from taking the SGSs from the shopping facility. In some embodiments, the SGS control circuit may identify that the SGS has moved beyond the threshold (e.g., through a notification from the central control system, a notification from an SGS tracking system, detecting a signal indicating a threshold boundary (e.g., RFID, loss of wireless signal strength, etc.), and the like), and implement methods to at least partially disable the SGS. For example, the SGS control circuit can cause the disabling of the SGS by in part preventing the control of the lenses in accordance with one or more frame profiles.

As described above, in some embodiments, the central control circuit may identify that the SGS has moved beyond the threshold. Accordingly, central control circuit can cause the SGS to be at least partially disabled through one or more methods, such as but not limited communicating a notice to the SGS to stop controlling the lenses and/or to force the lens to an opaque state, causing the content to no longer be communicated to the display systems, causing the frame profile and/or lens control timing information to no longer be communicated to the SGS, preventing one or more decryption keys from being communicated to the SGS that enable the SGS to decrypt information and/or content that is used to allow the SGS to operate and/or to effectively operate to view at least the intended content, preventing synchronization information to be communicated to the SGS, other such methods, or a combination of two or more of such methods.

In some instances, for example, the SGS control circuit is configured to receive one or more encrypted definitions of one or more frequency modulations of the content. The encrypted frequency modulation information in part enables the SGS to accurately control the lenses to be in synchronization with the frame profiles of the content. Accordingly, some embodiments the SGS control circuit can be configured to inhibits lens control of the SGS when the frame profile frequency modulation is unable to be decrypted. Further, some embodiments limit the rendering of content to content having the frame profiles consistent with the encrypted frequency modulation information. Still further, the central control system can prevent a communication of a decryption key to the SGS based on the detection that the SGS is beyond the threshold, and inhibiting the SGS to decrypt subsequent encrypted frequency modulation information inhibiting the SGS from continuing to control the lenses. Some embodiments cause the SGS to implement one or more actions to cause damage to the SGS (e.g., causing fuse in the SGS to trip, causing a conductor to melt, damaging a microchip or integrated circuit, etc.). The damage may be permanent, reversible, or repairable.

Additionally, however, the central control system can identify a location of the SGS while within the shopping facility and within the threshold. When within the threshold, the central control system can direct content to be displayed on at least one display located relative to the location of the SGS and at a frame profile or rates consistent with lens control timing such that the content is visible through the SGS to a corresponding customer while not being visible to one or more other customer through other SGSs.

Some embodiments may warn a customer as the customer approaches a threshold and/or after the customer has passed beyond a threshold. In some instances, the central control system identifies that the SGS is located beyond the threshold or another threshold corresponding to the shopping facility and causes one or more warning to be activated (e.g., a warning notification to be visible through the SGS). For example, a first threshold proximate to but interior to the shipping facility may trigger the warning, while a second threshold that is exterior to the shopping facility may trigger the disabling of the SGS. The warning may include one or more warnings such as but not limited to a warning notification being displayed on one or more displays proximate the warning threshold (which may be limited to only being visible through the SGS), causing the SGS to generate a warning (e.g., flashing lights, controlling the lenses in a predefined action (e.g., shifting to opaque for a predefined period, switching between opaque and transparent, causing one eye to stay opaque, etc.), vibrate, generate an audible output, other such warning methods or combination of such warning methods), causing an audible warning to be generated proximate the warning threshold, other such methods, or combination of such methods. For example, in some implementations, an SGS control circuit can be configured to identify that the SGS is located beyond a warning threshold corresponding to the shopping facility, and cause a warning notification to be generated through the SGS. As another example, the central control system can cause a notification to be communicated to a mobile user interface unit associated with the customer based on the detection that the SGS is located beyond one or more thresholds. Some embodiments may further cause multiple warnings based on multiple thresholds, and in some instances, the warnings may be different for each of the thresholds. For example, progressively more noticeable warnings may sequentially be generated as an SGS continues to move toward and/or beyond a series of two or more threshold boundaries. In instances, the warnings may vary depending on the customer, such as more threating warnings when the customer has a history of taking SGSs beyond one or more thresholds (e.g., the customer has removed multiple SGSs beyond a final threshold), whether the customer is believed to be a minor, whether the customer is accompanied by one or more other customers and the like. Similarly, one or more warnings may be directed to a different customer when an SGS is beyond a threshold, such as notifying a spouse or parent when an SGS beyond the threshold associated with a spouse or child of the customer being notified.

In some embodiments, the one or more of the displays may be configured to be controlled to be transparent during some periods of time and to display content during other periods of time. Such displays may be doors behind which actual products are stored and available to be retrieved by customers. Typically, the actual products are different that virtual products that are displayed on the display. This allows the central control system to control the displays and a customer's SGS so that the lens control timing is synchronized with a frame profile where the displays are transparent allowing a customer to see through the displays to actual products. Additionally or alternatively, some embodiments are configured to control the displays so that customers that are not wearing SGSs can view the products behind the displays and the display of virtual products are at a rate that does not interfere with the customer's viewing products behind the displays. By incorporating displays in front of actual products, the number of products and/or types of products available to customers for purchase can be significantly increased relative to the actual sales floor space that is occupied by the actual products.

In some embodiments, instructions and/or commands can be communicated to the SGSs to synchronize the lens control timing of the SGSs with the corresponding content intended to be viewed through the SGSs. The central control system can be configured to determine the frame profile at which content is to be rendered on one or more displays. Based on the frame profile, the central control system can cause one or more synchronization signals to be communicated to an SGS specifying at least the frame profile and/or lens control timing that enables a synchronization of the control of the lenses of the SGS with the frame profile of the content being displayed. As described above, the frame profile and thus the rate of control of the lenses can be varied over time while a customer is using an SGS. In some embodiments, for example, the central control system can cause a modulation over time of a frame profile in rendering a content in accordance with a modulation sequence. The modulation sequence can, for example, define different frame profiles and timing regarding when to apply the different frame profiles, can define code used to calculate a frame profile, or other such sequence. In some instances, the modulation sequence can be communicated to a set of one or more display systems that implement the modulation of the frame profile in accordance with the modulation sequence. In other instances, the central control system communicates instructions based on the sequence to cause the changes. In still other instances, one or more content sources can be controlled according to the modulation sequence in distributing frames in accordance with the modulation sequence. Further, in some embodiments, the central control system can cause lens control timing sequences cause a modulation over time of the lens control timing in accordance with the modulation sequence and/or a corresponding lens control timing sequence to provide synchronization between the SGS and the one or more display systems. For example, in some instances, one or more synchronization signals with respective SGSs further specify the modulation sequence to cause respective SGSs to modulate the control of the lenses of the SGS in synchronization with the changing frame profiles.

By virtually displaying products content (e.g., virtually rendered products, advertising of products, product information, etc.), the system can greatly increase the numbers of products that may be available for consideration by customers relative to an amount of actual physical floor area that would otherwise have to be available to support the products in a way that customers could retrieve the products. In some embodiments, the physical products displayed through the display systems can be stored in one or more storage locations. The storage locations can be more compact than would typically be positioned on a sales floor, can be stacked at levels that are higher than on sales floors, and the like, allowing a more optimized use of storage space and sales floor space. In some embodiments, when a customer selects a product to be purchased, a display system and/or a detection system can notify a worker and/or a retrieval system to cause the actual product to be retrieved from a storage location and subsequently provided to the customer, which may be prior to the customer leaves the shopping facility or through a delivery at a delivery location (e.g., home delivery, office delivery, etc.).

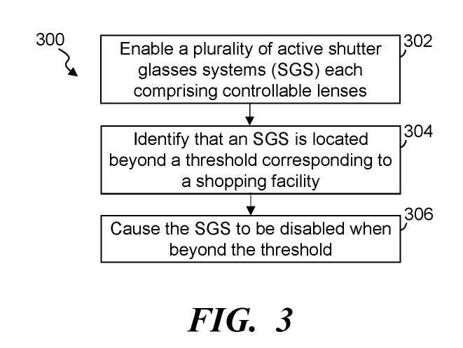

FIG. 3 illustrates a simplified block diagram of an exemplary process 300 of providing a customized retail shopping experience for customers at a shopping facility, in accordance with some embodiments. In step 302, a plurality of active SGSs are enabled. At least some of the plurality of SGSs include controllable lenses and/or lens control systems to each selectively control a rate of when one or both of the lenses are opaque and when one or both of the lenses are transparent. In step 304, it is detected that an SGS is located beyond a threshold corresponding to the shopping facility. In step 306, the system causes the SGS to be disabled when beyond the threshold.

As described above, some embodiments may additionally or alternatively disable other portable shopping facility supplied systems 110 that are available for use by customers and/or workers at a retail store and that are intended to remain at the retail store. The central control system 102 may track the location of and/or receive location information of one or more SGSs 104 and/or other portable systems 110 of the shopping facility supplied systems. The location information may be provided by the SGS or portable system, by sensor systems separate from the SGSs and/or portable systems, or other such devices. In some instances, the location information may simply be a notification of being within a threshold distance of a predefined boundary (e.g., an exit, a restroom, a cart coral, etc.), beyond a boundary, or other notification; while in other instances, the location information may provide a location relative to the shopping facility and the central control system 102 (and/or a control circuit of the SGS or other system) can determine whether the SGS 104 or other system has been transported beyond a boundary or within a threshold. The central control system 102 can trigger the SGS or other system to power down, transition to a sleep state, or otherwise modify the operation of the device (e.g., cause the device to generate an audible and/or visual alert, initiate a dimming of visual content, flashing visual content, etc.). Similarly, a notification may be communicated to a personal device carried by the person associated with that portable system (e.g., a text message to a customer or worker's smartphone). For example, in some embodiments, a first portable system, of a plurality of shopping facility supplied systems, may be identified as being beyond a boundary corresponding to the shopping facility and the first portable system. The system can cause the first portable system to be disabled when beyond the first boundary and/or otherwise modify the operation of the first portable system.

Some embodiments, in disabling an SGS, receive at the SGS an encrypted definition of a frame profile frequency modulation of the first content. The frame profile frequency modulation can define, for example, a timing of when to change frame profiles, and the changed frame profile corresponding to each change. The SGS can inhibit lens control of the SGS when the frame profile frequency modulation is unable to be decrypted. In some embodiments, a communication of a decryption key to the first SGS is prevented based on the detection that the SGS is beyond the threshold. Again, the system can limit the visibility of content to a customer. Some embodiments identify a location of an SGS while within the shopping facility and within the threshold, and direct the content to be displayed on one or more displays located relative to the location of the SGS and at a defined frame profile such that the content is visible through the SGS to the customer while not being visible to one or more other customers through other SGSs.

In causing the disabling of the SGS, some embodiments prevent the control of the lenses in accordance with a frame profile. Further, some embodiments identify, for example at the central control system, that the SGS is located beyond a warning threshold corresponding to the shopping facility, and the system can cause a warning notification to be visible through the SGS. Additionally or alternatively, in some embodiments an SGS control circuit of an SGS can identify that the SGS is located beyond a warning threshold corresponding to the shopping facility, and cause a warning notification to be generated through the SGS. Still further, some embodiments are configured to cause a notification to be communicated to a mobile user interface unit associated with a customer that is associated with an SGS based on a detection that the SGS is located beyond one or more thresholds.

The content to be displayed can in part be dependent on the customer viewing the content. Some embodiments identify products of interest to a customer based on an identification of the customer and a customer profile corresponding to the customer. Product content that is to be displayed to the customer can be identified that correspond to at least one of the products of interest. In some embodiments, the central control system accesses one or more databases storing value vector information corresponding to a customer and uses one or more of these value vectors to identify one or more products in which the customer is predicted to more likely purchase and/or be interested. Value vectors and their use are further described in U.S. Patent Application No. 62/323,026, filed Apr. 15, 2016, by Bruce W. Wilkinson et al., entitled Vector-Based Characterizations of Products and Individuals With Respect to Personal Partialities, which is incorporated herein by reference in its entirety.

In some embodiments, systems and corresponding methods performed by the systems that provide customized shopping experiences. Some embodiments provide systems comprising: a plurality of active shutter glasses systems (SGS) each comprising controllable lenses, wherein each of the SGS is configured to selectively control rates of when one or both of the lenses are opaque and when one or both of the lenses are transparent, wherein a first SGS of the plurality of SGSs is associated with a first customer while at the shopping facility and a second SGS of the plurality of SGSs is associated with a second customer while at the shopping facility; wherein the first SGS operates at a first frame profile at which the first SGS is to make a first content, intended for the first customer, visible to the first customer, and the second SGS operates at a different second frame profile at which the second SGS is to make a second content, intended for the second customer, visible to the second customer; wherein the first SGS based on the first frame profile prevents the first customer from seeing the second content and the second SGS based on the second frame profile prevents the second customer from seeing the first content; and a control circuit coupled with memory storing code that when implemented by the control circuit causes the control circuit to: identify that the first SGS is located beyond a first threshold corresponding to the shopping facility; and cause the first SGS to be disabled when beyond the first threshold.

Some embodiments provide methods of providing a customized retail shopping experience, comprising: enabling a plurality of active shutter glasses systems (SGS) each comprising controllable lenses to each selectively control a rate of when one or both of the lenses are opaque and when one or both of the lenses are transparent, wherein a first SGS of the plurality of SGSs is associated with a first customer while at the shopping facility and a second SGS of the plurality of SGSs is associated with a second customer while at the shopping facility; wherein the first SGS operates at a first frame profile at which the first SGS is to make a first content, intended for the first customer, visible to the first customer, and the second SGS operates at a different second frame profile at which the second SGS is to make a second content, intended for the second customer, visible to the second customer; wherein the first SGS based on the first frame profile prevents the first customer from seeing the second content and the second SGS based on the second frame profile prevents the second customer from seeing the first content; and identifying that the first SGS is located beyond a first threshold corresponding to the shopping facility; and causing the first SGS to be disabled when beyond the first threshold.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system providing a customized retail shopping experience, comprising:
a plurality of active shutter glasses systems (SGS) each comprising controllable lenses, wherein each of the SGS is configured to selectively control rates of when one or both of the lenses are opaque and when one or both of the lenses are transparent, wherein a first SGS of the plurality of SGSs is associated with a first customer while at the shopping facility and a second SGS of the plurality of SGSs is associated with a second customer while at the shopping facility; wherein the first SGS operates at a first frame profile at which the first SGS is to make a first content, intended for the first customer, visible to the first customer, and the second SGS operates at a different second frame profile at which the second SGS is to make a second content, intended for the second customer, visible to the second customer; wherein the first SGS based on the first frame profile prevents the first customer from seeing the second content and the second SGS based on the second frame profile prevents the second customer from seeing the first content; and
a control circuit coupled with memory storing code that when implemented by the control circuit causes the control circuit to:
identify that the first SGS is located beyond a first threshold corresponding to the shopping facility; and
cause the first SGS to be disabled when beyond the first threshold.

2. The system of claim 1, wherein the first SGS comprises an SGS control circuit wherein the SGS control circuit is configured to receive an encrypted definition of a frame profile frequency modulation of the first content and inhibits lens control of the SGS when the frame profile frequency modulation is unable to be decrypted.

3. The system of claim 2, further comprising:
a central control system separate from and in wireless communication with the plurality of SGSs, wherein the central control system comprises the control circuit that is configured to prevent a communication of a decryption key to the first SGS based on the identifying that the first SGS is beyond the first threshold.

4. The system of claim 3, wherein the central control system is configured to:
identify a first location of the first SGS while within the shopping facility and within the first threshold; and
direct the first content to be displayed on at least a first display located relative to the first location and at the first frame profile such that the first content is visible through the first SGS to the first customer while not being visible to the second customer through the second SGS.

5. The system of claim 1, wherein the first SGS comprises the control circuit that, in causing the disabling of the first SGS, prevents the control of the lenses in accordance with a frame profile.

6. The system of claim 1, further comprising:
a central control system separate from and in wireless communication with the plurality of SGSs, wherein the central control system is configured to identify that the first SGS is located beyond a second threshold corresponding to the shopping facility, and causes a warning notification to be visible through the first SGS.

7. The system of claim 1, wherein the first SGS comprises an SGS control circuit that is configured to identify that the first SGS is located beyond a second threshold corresponding to the shopping facility, and causes a warning notification to be generated through the first SGS.

8. The system of claim 1, further comprising:
a central control system separate from and in wireless communication with the plurality of SGSs, wherein the central control system is configured to cause a notification to be communicated to a mobile user interface unit associated with the first customer based on the identifying that the first SGS is located beyond the first threshold.

9. The system of claim 1, further comprising:
a plurality of portable shopping facility supplied systems communicatively coupled with the control circuit, wherein the control circuit is configured to:
identify that a first portable system, of the plurality of shopping facility supplied systems, is beyond a first boundary corresponding to the shopping facility and the first portable system; and
cause the first portable system to be disabled when beyond the first boundary.

10. A method providing a customized retail shopping experience, comprising:
enabling a plurality of active shutter glasses systems (SGS) each comprising controllable lenses to each selectively control a rate of when one or both of the lenses are opaque and when one or both of the lenses are transparent, wherein a first SGS of the plurality of SGSs is associated with a first customer while at the shopping facility and a second SGS of the plurality of SGSs is associated with a second customer while at the shopping facility; wherein the first SGS operates at a first frame profile at which the first SGS is to make a first content, intended for the first customer, visible to the first customer, and the second SGS operates at a different second frame profile at which the second SGS is to make a second content, intended for the second customer, visible to the second customer; wherein the first SGS based on the first frame profile prevents the first customer from seeing the second content and the second SGS based on the second frame profile prevents the second customer from seeing the first content;
identifying that the first SGS is located beyond a first threshold corresponding to the shopping facility; and
causing the first SGS to be disabled when beyond the first threshold.

11. The method of claim 10, further comprising:
receiving at the first SGS an encrypted definition of a frame profile frequency modulation of the first content; and
inhibiting lens control of the SGS when the frame profile frequency modulation is unable to be decrypted.

12. The method of claim 11, further comprising:
preventing a communication of a decryption key to the first SGS based on the identifying that the first SGS is beyond the first threshold.

13. The method of claim 12, further comprising:
identifying a first location of the first SGS while within the shopping facility and within the first threshold; and
directing the first content to be displayed on at least a first display located relative to the first location and at the first frame profile such that the first content is visible through the first SGS to the first customer while not being visible to the second customer through the second SGS.

14. The method of claim 10, wherein the causing the disabling of the first SGS comprises preventing the control of the lenses in accordance with a frame profile.

15. The method of claim 10, further comprising:
identifying, at a central control system, that the first SGS is located beyond a second threshold corresponding to the shopping facility; and
causing a warning notification to be visible through the first SGS.

16. The method of claim 10, further comprising:
identifying, through an SGS control circuit of the first SGS, that the first SGS is located beyond a second threshold corresponding to the shopping facility, and causes a warning notification to be generated through the first SGS.

17. The method of claim 10, further comprising:
causing a notification to be communicated to a mobile user interface unit associated with the first customer based on the identifying that the first SGS is located beyond the first threshold.

18. The method of claim 10, further comprising:
identifying that a first portable system, of a plurality of shopping facility supplied systems, is beyond a first boundary corresponding to the shopping facility and the first portable system; and
causing the first portable system to be disabled when beyond the first boundary.
